(19) United States
(12) Patent Application Publication
(10) Pub. No.: US 2023/0228130 A1
(43) Pub. Date: Jul. 20, 2023

(54) Opening and Closing Device for a Motor Vehicle

(71) Applicant: Weber GmbH & Co., KG, Dillenburg (DE)

(72) Inventor: Martin ZEIDLER, Dautphetal (DE)

(73) Assignee: Weber GmbH & Co., KG, Dillenburg (DE)

(21) Appl. No.: 18/152,853

(22) Filed: Jan. 11, 2023

(30) Foreign Application Priority Data
Jan. 17, 2022 (DE) 102022100995.5

(51) Int. Cl. E05B 81/20; E05B 81/06; E05B 81/30; E05B 81/34; E05B 81/44; E05B 81/90; E05B 83/28; B60L 53/16

(52) U.S. Cl. CPC E05B 81/20; E05B 81/06; E05B 81/30; E05B 81/34; E05B 81/44; E05B 81/90; E05B 83/28; B60L 53/16

(57) ABSTRACT

An opening and closing device (2) has a flap (24) that is rotatably arranged on a hinged arm, and an actuator (72) to actuate the flap (24). The actuator (72) is coupled to a rotatable spindle (62) that is coupled to a flap actuating element (12). As the spindle (62) is rotated, a translational and rotational movement is performed to close and move the flap (24).

### BACKGROUND OF THE INVENTION

### Technical Field and State of the Art

The invention relates to an opening and closing device, comprising a flap that is rotatably fastened to a hinge arm, and an actuator to actuate the flap.

Motor vehicles have flaps or lids on the body that, for example, conceal a charging port on electrical vehicles or a fuel neck on vehicles with combustion engines. The flap is in this case opened upward sideways when the electrical vehicle is to be charged and the charging port must be accessible. In the closed state, the flap must shield or isolate the charging port as best as possible against exterior and environmental influences. A gasket on which the flap rests in the closed state is typically also provided for this purpose.

The charging port must be accessible at the desired time to ensure that the motor vehicle is available and usable at any time. In particular, this means that the driver must be able to open the flap without using tools. External influences such as extreme cold, ice, or snow can significantly interfere with the ability to actuate the flap. Icing in particular can render opening and closing the flap difficult. During heavy snowfall, it can be difficult to bridge the gasket when closing the flap.

Actuators can be used to mechanically assist the user when operating the flap.

### SUMMARY OF THE INVENTION

An object of the invention is to provide a device with a flap that assists the user when opening and closing the flap. A corresponding method is also specified.

According to the invention, the actuator is coupled to a rotating spindle that is coupled to a flap actuator element, such that the flap actuator element performs a translational and rotational movement when the spindle is rotated to close and move the flap. Advantageous embodiments of the invention are the subject matter of the dependent claims.

The invention is based on the idea that a device is to assist the user by exerting an opening and closing force when the flap is actuated. The device is therefore intended to provide an increased opening and closing force.

This assisting functionality is to be provided over a predetermined path, originating from the closed position.

As was now recognized, these requirements can be met by rotationally driving a spindle such that an axial force exertion is realized on the flap in interaction with a flap actuator element.

The actuator is advantageously formed as an electric motor with a gear screw that drives a worm gear arranged on the spindle, wherein the gear screw is arranged vertically in relation to the axial direction of the spindle.

By this arrangement, closing does not require deflecting the forces, as is the case for a translational movement. The worm drive permits realizing a desired self-locking effect.

The flap actuating element preferably has a key element with an inner thread that engages with an outer thread of the spindle, wherein a locking sleeve is provided that sectionally surrounds the key element, and wherein the locking sleeve has a guide groove and the key element has a cam movable therein.

The spindle therefore exclusively drives the key element axially. The additionally achievable rotation of the key element is generated by the forced condition by the connecting link and/or guide groove. The axial actuation of the key element using the guide groove and/or connecting link control can then at the desired time be converted into a rotational movement to engage in a lock on the flap. Moreover, it permits a direct rotational impulse for emergency unlocking.

The guide groove preferably has a first region extending in an axial direction of the locking sleeve, and a region adjoining thereto that has a vertical component in relation to the axial direction. The guide groove is advantageously S-shaped, with a section initially extending axially from one end of the locking sleeve, a further axial section, and an intermediate section connecting these two sections, wherein the guide groove also has a section extending vertically in relation to the axial direction in said intermediate section.

The key element has at least one locking element on one end, wherein the locking element can be engaged into the lock on the flap. The lock can be arranged or fastened on the inner side of the flap, or can be integrally formed with the latter. The lock geometry has the negative of the locking hooks and in this manner arranges the engagement and/or insertion of the deployed key, e.g., the head end of the key element with the locking elements.

In a preferred embodiment of the invention, the flap has a separate electrical drive for the complete opening and closing movement. The inventive device in particular performs the last/first path, in particular the last/first 10 mm of the closing/opening path with increased force and locks the flap in the closed position.

Preferably, two locking elements are provided that are each adapted as locking hooks, therefore permitting symmetrical and stable locking.

A preferred embodiment of the invention provides an emergency unlocking device. In this manner, the flap can also be opened, in particular manually, if the actuator malfunctions or fails.

The emergency unlocking device preferably has teeth that engage with the teeth of a locking sleeve. The emergency unlocking device is advantageously rod-shaped. When the device operates normally, e.g., with operable actuator, it prevents the rotation of the locking sleeve, such that the guide groove of the latter can predetermine the translational and/or rotational movement for the key element. For emergency unlocking, the emergency unlocking device is moved such that the locking sleeve is rotated as a result. This also rotates their key element and unlocks the flap. This embodiment permits use of a self-locking drive since the actuator does not need to be actuated for emergency unlocking.

Preferably at least one button and/or sensor is provided on the end of the spindle facing away from the flap. The button is used in particular to realize the push-to-open functionality. The key element is rotated to unlock the flap when the operator presses the flap in the direction of the vehicle and actuates the button.

The device preferably has a housing, wherein in particular the spindle braces itself in axial direction on the housing with a compression spring. The spring can be used to regulate the push force needed for push-to-open. The total push force is generated by overcoming the main drive (if the flap is moved electrically), by overcoming the gasket, and said spring.

A lid is preferably provided to cover the housing. The lid is preferably attached on the side of the housing facing away from the key element, and therefore in the installed state also on the side facing away from the flap, and simplifies access to the components of the device. Arranging the components in the housing facilitates integrating the components, thus achieving simple operation. The components are also protected against external influences, such as moisture, snow, or dirt.

The key element and the spindle are advantageously arranged in the housing to be axially translatable together, thus achieving the push-to-open function. In this manner, the push motion is decoupled from the worm drive. The push force is then only generated by overcoming the main drive of the flap and by overcoming an in particular present rubber gasket and spring pretension within the device.

In a preferred embodiment, the flap is formed as a charging flap for an electrical charging port of a motor vehicle. It is arranged rotatably on the vehicle, in particular on the vehicle body. The invention also relates to a motor vehicle with a device as described above, wherein the flap is rotatably arranged on the vehicle, preferably on the vehicle body.

The advantages of the invention in particular include that an electric motor, including contacting and control electronics, can be omitted. The device has a low propensity to malfunction since no moving parts are arranged in the externally accessible region of the actuator unit. A robust design against misuse forces is possible. A robust two-stage gearbox with a simple design is provided using a drive worm gear on a motor shaft of an actuator and a spindle with gear. The push-to-open functionality requires working against the spring force of a compression spring, therefore simplifying operation.

The device is suited for all lids and/or flaps for which an additional force makes sense when opening or closing these. It represents an assisting opening/closing motion and locking action for various types of flaps/doors.

The device performs a dual function. Firstly, it is used as assistance when opening and closing the flap, in particular as an ice breaker in iced-over situations. Secondly, it is used to lock the flap, which can in particular be used as part of the motor vehicle's central locking mechanism.

### DESCRIPTION OF THE DRAWINGS

An embodiment of the invention is explained in greater detail based on the drawings. All described and/or depicted features per se or in any combination constitute the subject matter of the present invention, regardless of their summary in the patent claims or their back-reference. Partially schematically, the drawings show in:

FIG. 1 an opening and closing device with a flap, a housing, and an actuator in a preferred embodiment,

FIG. 2 components of the device according to FIG. 1 in an exploded view,

FIG. 3 components of the device according to FIG. 1 in a side view, and

FIG. 4 a cross section through FIG. 3.

In all figures, the same parts are labeled with the same reference symbols.

### DETAILED DESCRIPTION

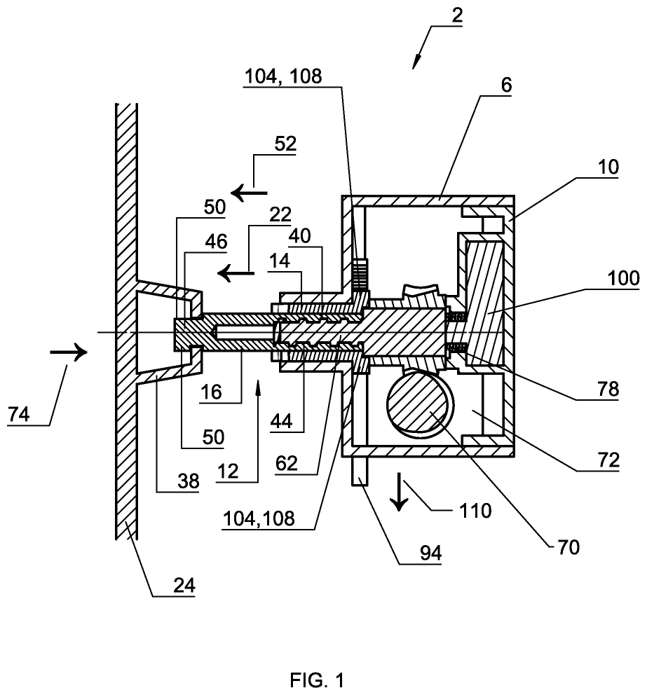

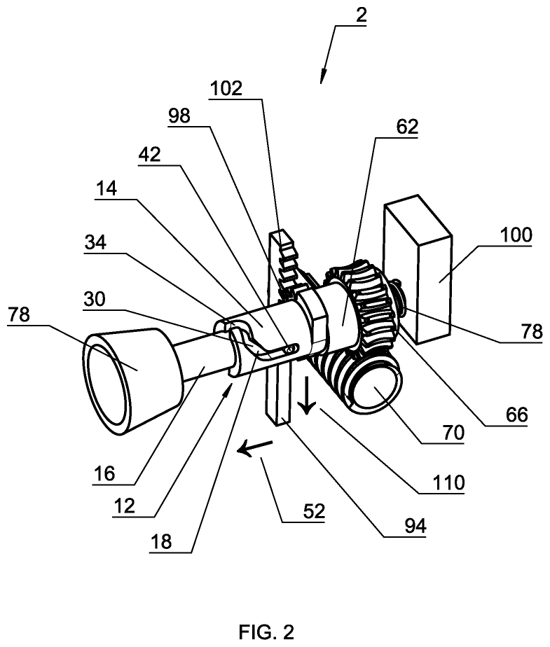

FIG. 1 and FIG. 2 show an opening and closing device 2 that has a housing 6 that can be closed with a housing lid 10. A locking sleeve 14 is rotatably guided in the housing 6 of the device 2. The locking sleeve 14 has a connecting link guide and/or a guide groove 18, which in a first section and/or region 26 runs parallel to an axial direction 22 of the locking sleeve 14, and then in a second section and/or region runs in an S shape, and in a third section and/or region 34 again runs parallel to the axial direction 22.

A key element 16 that has a cam 42 is regionally arranged in the locking sleeve 14. The key element 16 acts as a flap actuating element 12. The guide groove 18 is adapted to match the locking geometry. It results from the angle of the required rotation to securely engage the key element 16 in the lock and from the axial motion within which the increased force of the opening/closing action of the flap is required.

The third section 34 of the guide groove 18 is used to insert the key element 16 into the locking sleeve 14. The two sections 26 and 30 of the guide groove are relevant for the functionality of the device 2 because they facilitate an axial actuation of a flap 24 and a locking action of the flap 24.

The device 2 accordingly has a flap 24 that is connected to a lock 38. The lock 38 can be fastened to the flap 24. The flap 24 and lock 38 can also be formed integrally.

A key element 16 has a cam 42 that engages into the guide groove 18. The connecting link guide rotates the locking sleeve 14 in the motion about its length axis. The key element 16 also has a head region 46 with preferably two locking hooks 50 (the Figure only shows one locking hook 50), which in the extended position of the locking sleeve 14 engage in the lock 38 based on the key-lock principle.

When the flap 24 is closed, the locking hooks 50 are forcibly rotated by the connecting link guide and/or guide groove 18 into an undercut 38. In this manner the required tensile forces can be transferred during the closing action of the flap 24. The locking sleeve 14 furthermore has an end part 104 with a flange 108. The flange 108 of the locking sleeve 14 is initially circumferential, but is then cut back in order to circumcise around the teeth, which engage into an emergency unlocking device 94, and cut back again to permit and/or limit the rotation when the emergency unlocking feature is actuated.

The device 2 comprises a spindle 62 that is connected rotationally fixed with a worm gear 66. The spindle 62 and the worm gear 66 can also be formed integrally. The spindle 62 is driven by an actuator 72 with a gear screw 70. The actuator 72 and the gear screw 70 then form a worm drive. The gear screw 70 and the spindle 62 with the gear 66 form a robust, two-stage gearbox with a straightforward design. The spindle 62 and the gear screw 70 and/or drive screw supply the required self-locking effect in the system, such that a separate locking feature, for example with the assistance of a furthermore/actuator, can be omitted.

The spindle 62 has an outer thread 40, and the key element 12 has a corresponding inner thread 44. The outer thread 40 of the spindle 62 preferably has a pitch in the range from 2 mm to 8 mm, in particular 5 mm.

As mentioned above, the device 2 has the emergency unlocking device 94, which is substantially rod-shaped and has teeth 102 that engage with teeth 98 on the worm gear 66. In this manner, the emergency unlocking device 94 prevents the rotation of the locking sleeve 14 when the device 2 is in normal operating mode, e.g., when the actuator 72 is operable.

The axial components of the device 2, e.g., the key element 16, the locking sleeve 14, and the spindle 62 are held at rest by a compression spring 78. The worm gear 66 and the locking sleeve 14 are blocked and/or fixed in the housing by the housing lid 10. The spring 78 presses the spindle 62 against the locking sleeve 14, therefore holding the spindle 62 at rest. The engagement of the thread connects the key element 16 to the spindle 62, therefore also holding key element 16 at rest.

The compression spring 78 is arranged in axial direction between a button 100 and the spindle 62. The push force is substantially determined by the compression spring 78 together with the resistance of the actuator (not shown) for the total motion of the flap 24 and the flap gasket.

FIG. 2—which does not show the flap 24 for better comprehension—shows the device 2 with the flap 24 in a closed position. For assisted opening of the flap 24, the actuator 72 rotates the gear screw 70, causing the worm gear 66 to rotate. This also causes the spindle 62 to rotate and causes the key element 16 to perform an axial stroke and to move in an opening direction 52 as long as the cam 42 travels in the first region 26 of the guide groove 18. The flap 24 can be lifted in this manner. The locking hooks 50 are in this case engaged in the lock 38.

As the spindle 62 continues to rotate, the cam 42 travels into the second region, which not only extends in axial direction 22, but also has a component vertical thereto. This causes the key element 16 to simultaneously perform an axial motion and/or translation and a rotation. In this manner, the locking hooks 50 are disengaged in the lock 38, and the flap 24 can be opened. The flap 24 is closed by moving the components in the respectively opposite direction and/or rotational direction.

In order to realize a push-to-open function the key element 16—together with the spindle 62—is arranged in the locking sleeve 14 to be translationally moved by a push path. When the user pushes on the flap 24 in push direction 74, the key element 16 and the spindle 62 are together translated in this direction against the pressure of the compression spring 78 until the button 100 is actuated. When the button 100 is actuated, the actuator 72 can be actuated such that the regular opening process is initiated, which includes starting assisted opening.

The device 2 can also comprise two or several buttons 100 that have different functions and are actuated at a different axial stroke of the spindle 62 and key element 16.

In a preferred embodiment, a sensor is used in place of a button. In this embodiment, a pin that extends through the spindle 62 up to the sensor is preferably installed and/or inserted in the key element 16. In this manner, the sensor detects the axial position of the key element 16, which represents the position of the flap 24 within the actuating path. Other functionalities can then also be realized apart from the push-to-open functionality.

According to the example, the requirement can be met that as the flap 24 is closed, the latter travels beyond the closed position by a predetermined path, e.g., 2 mm to pre-compress the gasket, and then travels back to the final closed position. A button with several actuating points can also be used in place of a sensor or a pin. This functionality can also be omitted, and only the push can be detected by a simple button.

In normal operating mode, the emergency unlocking device 94 ensures that the locking sleeve 14—which determines the movement of the key element 16 with its guide groove 58—does not rotate. For emergency unlocking, the emergency unlocking device 94 is moved in an emergency unlocking direction 110 such that the mutual engagement of the teeth 98, 102 together rotates the key element 16, therefore unlocking the lock 38. The ability of the locking sleeve 14 to rotate can in this manner realize the emergency unlocking function for a self-locking actuator 72.

The device 2 preferably comprises a bellows (not shown in the figures) as protection against external influences, and therefore represents a fully encapsulated system.

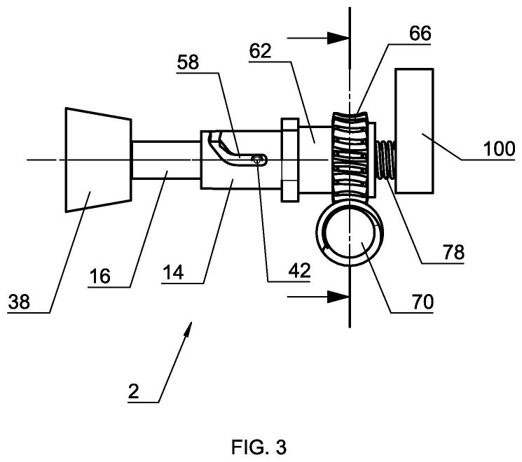

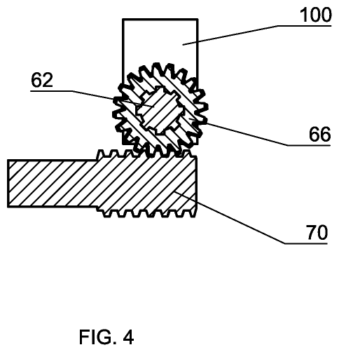

FIGS. 3 and 4 show components of the device according to FIG. 1 in a side view and in a cross-sectional view.

### REFERENCE NUMERALS

2 Opening and closing device
6 Housing
10 Housing lid
12 Cover actuating element
14 Locking sleeve
16 Key element
18 Guide groove
22 Axial direction
24 Flap
26 First section
30 Second section
34 Third section
38 Lock
40 Outer thread
42 Cam
44 Inner thread
46 Head section
50 Locking hook
52 Opening direction
62 Spindle
66 Worm gear
70 Gear screw
72 Actuator
74 Push direction
78 Compression spring
94 Emergency unlocking device
98 Teeth
100 Button
102 Teeth
104 End section
108 Flange
110 Emergency unlocking direction

1. An opening and closing device (2), comprising:
a flap (24) that is rotatably fastened to a hinge arm,
a flap actuating element (12),
a rotatable spindle (62) that is coupled to the flap actuating element (12) such that the flap actuating element (12) performs a translational and rotational movement to lock and move the flap (24) when the spindle (62) rotates, and
an actuator (72) coupled to the rotatable spindle (62) and configured to rotate the rotatable spindle (62).

2. The device (2) according to claim 1, wherein the actuator (72) is an electric motor with a gear screw (70) that actuates a worm gear (66) arranged on the rotatable spindle (62), and wherein the gear screw (70) is arranged vertically in relation to the axial direction of the rotatable spindle (62).

3. The device (2) according to claim 1, wherein the flap actuating element (12) has a key element (16) with an inner thread (44) that engages with an outer thread (40) of the rotatable spindle (62), and wherein a locking sleeve (14) is provided that sectionally surrounds the key element (16), and wherein the locking sleeve (14) has a guide groove (18) and the key element (16) has a cam (42) movable therein.

4. The device (2) according to claim 3, wherein the guide groove (18) has a first region and/or section (26) extending in an axial direction (22) of the locking sleeve (14) and an adjacent second region and/or section (30) extending at an angle to the axial direction (22).

5. The device (2) according to claim 3, wherein the key element (16) on one end has at least one locking element that can be engaged in a lock (38) on the flap (24).

6. The device (2) according to claim 5, wherein two locking elements are provided that are each adapted as locking hooks (50).

7. The device (2) according to claim 1, further comprising an emergency unlocking device (94).

8. The device (2) according to claim 7, wherein the emergency unlocking device (94) has teeth (102) that engage with teeth (98) of a locking sleeve (14) that sectionally surrounds the key element (16), and wherein the locking sleeve (14) has a guide groove (18) and the key element (16) has a cam (42) movable therein.

9. The device (2) according to claim 1, further comprising at least one button (100) and/or sensor on the end of the spindle (62) facing away from the flap (24).

10. The device (2) according to claim 1, further comprising a housing (6), wherein the spindle (62) is braced in axial direction on the housing (6) by a compression spring (78).

11. The device (2) according to claim 10, wherein the key element (16) and the spindle (62) are arranged in the housing (6) to be axially translatable together.

12. The device (2) according to claim 1, wherein the flap (24) is adapted as a charging flap for an electrical charging port.

13. A method for assisted opening and/or closing a rotatably arranged flap with the device (2) according to claim 1, comprising:
rotating the rotatable spindle (62) with the actuator (72), wherein the rotatable spindle (62) is coupled to the flap actuating element (12), so that as the rotatable spindle (62) is rotated, the flap actuating element (12) performs a translational and rotational movement to axially actuate the flap (24) and thereby close the flap (24).

14. A method for assisted opening and/or closing of a rotatably arranged flap (24), comprising:
rotating a rotatable spindle (62) with an actuator (72), wherein the rotatable spindle (62) is coupled to a flap actuating element (12), so that as the rotatable spindle (62) is rotated, the flap actuating element (12) performs a translational and rotational movement to axially actuate the flap (24) and thereby close the flap (24).
